(19) United States
(12) Patent Application Publication
(10) Pub. No.: US 2010/0323134 A1
(43) Pub. Date: Dec. 23, 2010

(54) Laminate with Aroma Burst

(75) Inventors: David Hoyt Bostian, Columbus, WI (US); Joseph Donald Gagne, Holyoke, MA (US); Matthew Henry Lang, Appleton, WI (US)

Correspondence Address: QUARLES & BRADY LLP, 411 E. WISCONSIN AVENUE, SUITE 2040, MILWAUKEE, WI, 53202-4497, US

(73) Assignee: Appleton Papers Inc.

(21) Appl. No.: 12/489,587

(22) Filed: Jun. 23, 2009

(51) Int. Cl. B32B 1/02; B32B 5/16

(52) U.S. Cl. 428/35.2; 428/323

(57) ABSTRACT

The present invention is a laminate and resultant package expressing an aroma burst. The laminate or package is comprised of a polyolefin sealing layer; a pressure sensitive adhesive layer and microcapsules containing an active core material, the microcapsules dispersed in a resealably tacky pressure sensitive adhesive layer; the pressure sensitive adhesive sandwiched between at least two layers by being disposed along substantially an entire surface of the polyolefin sealing layer and in continuous and direct contact with a second polyolefin layer opposing and coextensive with the polyolefin sealing layer; and the microcapsules in the pressure sensitive adhesive layer having less tensile strength than the adhesive such that a fraction of the microcapsules rupture releasing core material such as an aroma or fragrance when the pressure sensitive adhesive layer is separated when the polyethylene and first polyolefin layers sandwiching the pressure sensitive adhesive are pulled apart. The laminate polyolefin sealing layer can have a portion such as one or more edge areas that are sealed to itself or a second laminate forming a lumen or chamber area. The lumen area is physically isolated from the pressure sensitive adhesive and microcapsule layer by a polyolefin layer until the polyolefin layer is ruptured.

### FIELD OF THE INVENTION

This invention relates to film structures useful in the manufacture of packaging, particularly packaging useful in the food industry.

### DESCRIPTION OF THE RELATED ART

Packaging films consist of multiple polyolefin film layers. Such laminates have many uses such as in the food industry for food packaging in the formation of various flexible pouches. Polyolefins are polyalkenes and the more common polyalkenes include polyethylene and polypropylene. Oriented polyolefin layers such as oriented polypropylene have also been advantageously used.

U.S. Patent Application 2003/0204001 Van Gelder et al. describes a plastic film blended with fragrance and a waxy fatty-acid amide.

Turnbull U.S. Pat. No. 4,487,801 describes a fragrance release pull apart sheet. In the example, aroma of Concord grapes was microencapsulated in a urea formaldehyde resin, and the capsules formed into a coating applied as a stripe down the middle of a paper.

Dobler U.S. Patent Application 2009/0050506 describes fragrance samplers and at column 1 provides an overview of Scentstrip™ magazine fragrance inserts using microcapsules bonded to paper.

Ashcraft et al. U.S. Pat. No. 5,249,676 describes a structure with a flavor burst comprising a laminated multilayer polymeric film. In Ashcraft's laminate the flavorant is applied in a selected area and released upon delamination of the laminate. Resealability is not contemplated, nor is there discussion of for example the present invention's security achievable with a rupturable web layer separate from the package lumen.

U.S. Patent Application 2006/0291756 Thomas et al. describes a web material where an active agent is selectively prepositioned so as to be in communication with the web compartment formed. A separate closure device is also added to the web. The Thomas system requires costly additional steps of positioning and inserting a closure device along with applying the active agent strip or layer so that it is in communication with the compartment formed from the web.

### BRIEF DESCRIPTION OF THE DRAWING

FIG. 1 depicts two laminates according to the invention with melt fused layers 13 where the two laminates meet. The capsules in layer 12 are isolated from the lumen formed from areas where layers 13 are not melt fused. The laminates are preferably melt fused near edges.

FIG. 2 is a view of a roll of an alternate embodiment of a laminate according to the invention.

FIG. 3 is an alternative embodiment of a laminate according to the invention used as a lid where a seal layer separates as the lid is retracted.

FIG. 4 is a yet further embodiment where the laminate splits along a glue layer along the rim of the container.

FIG. 5 is a cross-section of a laminate according to the invention used in sealing a container.

FIG. 6 is a view of a three layer laminate according to the invention formed into a package using a fin seal.

FIG. 7 is a view of a three layer laminate according to the invention formed into a package using a lap seal.

### SUMMARY OF THE INVENTION

The present invention is a laminate and resultant package expressing an aroma burst. The laminate or package is comprised of a polyolefin sealing layer; a pressure sensitive adhesive layer and microcapsules containing an active core material, the microcapsules dispersed in a resealably tacky pressure sensitive adhesive layer; the pressure sensitive adhesive sandwiched between at least two layers by being disposed along substantially an entire surface of the polyolefin sealing layer and in continuous and direct contact with a second polyolefin layer opposing and coextensive with the polyolefin sealing layer. The microcapsules in the pressure sensitive adhesive layer having less tensile strength than the adhesive such that a fraction of the microcapsules rupture releasing core material such as an aroma or fragrance when the pressure sensitive adhesive layer is separated when the polyethylene and first polyolefin layers sandwiching the pressure sensitive adhesive are pulled apart. The adhesive layer is designed to split apart. The laminate polyolefin sealing layer can have a portion such as one or more edge areas that are sealed to itself or to a second laminate forming a lumen. Lumen for purposes hereof is intended to encompass chamber, pocket, pouch, baggie, package interior, container interior, cavity, interior volume, and interior space. All such terms are equivalent for purposes hereof. The lumen area is physically isolated from the pressure sensitive adhesive and microcapsule layer by a polyolefin layer until the polyolefin layer is ruptured.

Preferably the polyolefin sealing layer is a low density polyethylene, or even a polyolefin elastomer-modified polyethylene.

In one embodiment, the polyolefin layer opposing the sealing layer is a top layer of the laminate and is selected from films consisting of polypropylene, oriented polypropylene, biaxially oriented polypropylene polyethylene and elastomer-modified polyethylene. Optionally the laminate can include additional polyolefin layers or other substrates and preferably in addition one to eight additional polyolefin layers.

In a further embodiment a pouch can be made by heat sealing the sealing layers of two laminates.

In a yet further embodiment an article is made by heat sealing areas of the sealing layer of a laminate according to the invention to itself forming a fin seal and lumen area, or lap seal and lumen, or both types of seal and lumen or chamber for packaging contents.

In an alternate embodiment a laminate is disclosed comprised of a low density polyethylene sealing layer forming one side of said laminate; a pressure sensitive adhesive layer and microcapsules containing an active core material, the microcapsules dispersed in the pressure sensitive adhesive layer; the pressure sensitive adhesive sandwiched between at least two layers of the laminate by being disposed along substantially an entire surface of the low density polyethylene sealing layer and in continuous and direct contact with a first polyolefin layer opposing and coextensive with the low density polyethylene sealing layer, the first polyolefin layer forming an opposing side of the laminate. A pouch can be made by heat sealing the polyethylene sealing layers of two laminates according to this embodiment, or by overlapping and heat sealing the polyethylene sealing layer of the laminate to itself.

Optionally and in addition the laminate further comprises at least a second polyolefin layer disposed over the first polyolefin layer; the microcapsules in the pressure sensitive adhesive layer having less tensile strength than the adhesive such that a fraction of the microcapsules rupture releasing core material when the pressure sensitive adhesive layer is separated when the polyethylene and first polyolefin layers sandwiching the pressure sensitive adhesive are pulled apart.

In an alternate embodiment a container is disclosed comprising a first laminate heat sealed to a second laminate, the first laminate comprising at least one low density polyethylene sealing layer and a polyolefin layer, the second laminate being in the shape of a container, the polyethylene sealing layer forming a top surface of the container.

The second laminate comprises a low density polyethylene sealing layer; a pressure sensitive adhesive layer and microcapsules containing an active core material. The microcapsules are dispersed in the pressure sensitive adhesive layer. The pressure sensitive adhesive is sandwiched between two layers by being disposed along substantially an entire surface of the low density polyethylene sealing layer and in continuous and direct contact with a first polyolefin layer opposing and coextensive with the low density polyethylene sealing layer; and optionally at least a second polyolefin layer or other substrate disposed over or under the first polyolefin layer.

The microcapsules in the pressure sensitive adhesive layer are fashioned to have less tensile strength than the adhesive such that a fraction of the microcapsules rupture releasing core material such as aroma when the pressure sensitive adhesive layer is separated when the polyethylene and first polyolefin layers sandwiching the pressure sensitive adhesive are pulled apart when the first laminate is pulled from the second laminate.

In a yet further embodiment a container is disclosed comprising a first laminate and a second laminate, the first laminate comprising at least one low density polyethylene sealing layer and a polyolefin layer, the second laminate being in the shape of a container, the polyethylene sealing layer forming a top surface of the container.

The second laminate comprises a low density polyethylene sealing layer; a pressure sensitive adhesive layer and microcapsules containing an active core material, the microcapsules dispersed in the pressure sensitive adhesive layer; the pressure sensitive adhesive sandwiched between two layers by being disposed along substantially an entire surface of the low density polyethylene sealing layer and in continuous and direct contact with a first polyolefin layer opposing and coextensive with the low density polyethylene sealing layer; and at least a second polyolefin layer disposed over the first polyolefin layer; whereby the sealing layers of the first laminate and the second laminate can be heat sealed together to close the container.

In a yet further embodiment, disclosed is a package having an aroma burst, the package comprising a laminate comprised of a polyolefin sealing layer; a pressure sensitive adhesive layer and microcapsules containing an active core material, the microcapsules dispersed in a resealably tacky pressure sensitive adhesive layer; the pressure sensitive adhesive sandwiched between at least two layers by being disposed along substantially an entire surface of the polyolefin sealing layer and in continuous and direct contact with a second polyolefin layer opposing and coextensive with the polyolefin sealing layer; and the microcapsules in the pressure sensitive adhesive layer having less tensile strength than the adhesive such that a fraction of the microcapsules rupture releasing core material when the pressure sensitive adhesive layer is separated when the polyethylene and first polyolefin layers sandwiching the pressure sensitive adhesive are pulled apart, the laminate polyolefin sealing layer having a portion being sealed to itself or to a second laminate. The bond of the adhesive layer is less strong than the bond of the heat sealing layer when heat sealed to itself or another heat sealing layer. Therefore the adhesive layer preferentially separates first when the layers of the laminate are attempted to be pulled apart.

In the package according to this embodiment a lumen can be formed when the laminate is sealed to itself or to a second laminate, the pressure sensitive adhesive layer being isolated from the lumen by a continuous polyolefin layer until the polyolefin layer is ruptured.

In a further embodiment the heat sealable laminate of the invention is comprised of at least three layers comprising an oriented polypropylene film layer on one side of said laminate, and a polyolefin elastomer-modified polyethylene sealant film forming an opposing side of a laminate, an interior layer of said laminate comprising a resealable pressure sensitive adhesive layer and microcapsules containing an active core material, the microcapsules dispersed in the resealable pressure sensitive adhesive; the pressure sensitive adhesive layer sandwiched between the oriented polypropylene film layer and the polyolefin elastomer-modified polyethylene sealant film layers and substantially coextensive with the polypropylene film and polyethylene sealant film layers; the microcapsules in the pressure sensitive adhesive layer having less tensile strength than the adhesive such that a fraction of the microcapsules rupture releasing core material when the pressure sensitive adhesive layer is separated when the polyethylene sealant film layer and polypropylene film layers sandwiching the pressure sensitive adhesive are pulled apart.

Preferably, the sealant film is comprised of a mixture of polyolefin elastomer and a polyolefin plastomer, such as a polypropylene elastomer and a polyethylene sealant material

Desirably, the oriented polypropylene film is a biaxially oriented polypropylene film. The laminate can further comprise a barrier layer intermediate the oriented polypropylene layer and the polyethylene film layer. Preferably the barrier layer is comprised of EVOH.

More preferably the polypropylene polymer of the laminate is formed from a monomer represented by the formula H₂C═CR₁R₂ wherein, independently, R₁ may be H or a C₂-C₆ alkyl group, and R₂ is H, a C₂-C₆ alkyl group, or a C(O)OR₃ group wherein R₃ is H or a C₂-C₆ alkyl group. Preferably the polyethylene sealant film of the laminate is comprised of low density polyethylene (LDPE), linear low density polyethylene (LLDPE), linear medium density polyethylene (LMDPE), linear very low density polyethylene (VLDPE), linear ultra low density polyethylene (ULDPE), metallocene linear low density polyethylene (MLLDPE), high density polyethylene (HDPE), Polyolefin Plastomer (PO), or mixtures thereof.

Desirably the polyolefin elastomer is present in the polyethylene sealant film in an amount of from about 1 to about 25 percent by weight. In this embodiment or any of the above embodiments, the laminate can further optionally include one or more, preferably one to eight, or even one to 16 or more additional layers intermediate the outer layers. The additional layers can comprise a layer selected from foil, nylon, polyvinylidene chloride, polyethylene terephthalate, oriented polypropylene, ethylene/vinyl acetate copolymers, paper, ethylene/acrylic acid copolymers, ethylene/methacrylic acid copolymers, EVOH, paper, and polyethylene.

### DETAILED DESCRIPTION

The present invention relates to laminates useful as packaging materials and/or containers for goods. The laminates of the invention can efficiently and economically be fashioned into packaging, flexible containers and lids for rigid containers, reclosable plastic bags, storage containers, food containers, trash bags, flexible pouches, sandwich bags, and the like useful for packaging, storing, or extending the useful life of perishable items.

According to one embodiment, the invention discloses a laminate comprised of a polyethylene, preferably a low density polyethylene sealing layer. This layer advantageously lends itself to ease of heat sealing with itself or to another similar layer on a second laminate or a sealing layer on a container. The laminate, in addition to the low density polyethylene sealing layer also has a pressure sensitive adhesive layer along with microcapsules dispersed in the pressure sensitive adhesive layer.

The pressure sensitive adhesive layer is sandwiched between two layers by being disposed along substantially an entire surface of the low density polyethylene sealing layer. The pressure sensitive adhesive layer is also in continuous and direct contact with a first polyolefin layer opposing and coextensive with the low density polyethylene sealing layer. Optionally at least a second polyolefin layer can be disposed over the first polyolefin layer. The microcapsules in the sandwiched pressure sensitive layer are fashioned to have less tensile strength than the adhesive such that a fraction of the microcapsules rupture releasing core material from the microcapsules when the pressure sensitive adhesive layer is pulled apart or separated. This for example would occur when the polyethylene layer and first polyolefin layers sandwiching the pressure sensitive adhesive are pulled apart.

Since the microcapsules are dispersed throughout the pressure sensitive adhesive layer no prepositioning or separate insertion step is required.

Core material for purpose of the invention is the encapsulate and can include benefit agents such as fragrances, aromas, or materials providing a flavor burst or aroma. Preferably, the core material can be an active core material selected from perfumes, fragrances, aromas, essential oils, flavor enhancers, flavorants, or optionally the active core material can be any of the various active agents such as described in U.S. 2006/0291756 incorporated herein by reference. Active core materials can include freshness extenders, odor maskers, drying agents, gases, gas generators, inhibitors, indicators, or any beneficial material lending itself to delivery via microcapsule.

Although the invention is illustrated emphasizing an aroma burst achievable in food packaging, the invention is not to be construed as limited simply to aroma delivery, as evident from the above discussion of the various benefit agents able to be encapsulated and dispersed in the pressure sensitive adhesive of the laminate.

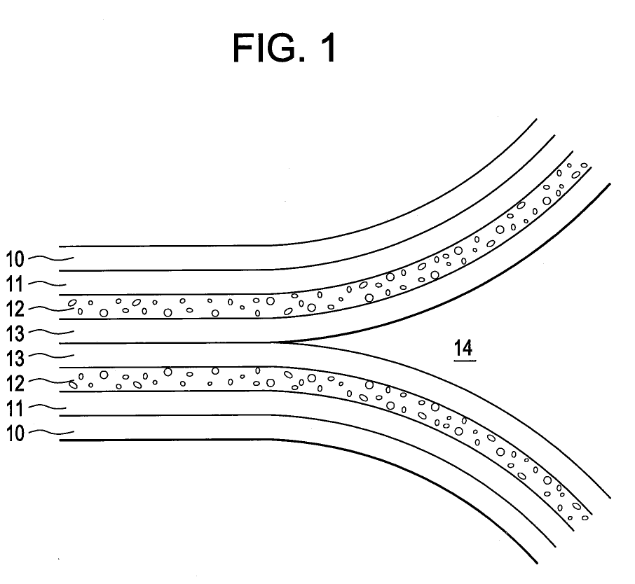

In a preferred aspect of the invention, as depicted in FIG. 1, two laminates can be heat sealed together by mating edge areas of low density polyethylene sealing layers to each other. The sealing could be of just the edge areas. In modern filling apparati, the laminate is rolled onto itself in a conical shape and the edges sealed using a fin seal or lap seal. The bottom portion can be press sealed and folded over to impart more strength to the bottom of the container.

Unlike in prior art constructions, the microcapsules containing an active core material are dispersed throughout the pressure sensitive adhesive layer. Further the pressure sensitive layer is sandwiched between the low density polyethylene sealing layer and the first polyolefin layer. The laminate core material therefore is always isolated from the interior of a formed package, bag or container by the polyethylene sealing layer or a polyolefin layer, until such time that the layer is deliberately ruptured.

Processes of microencapsulation are well known in the art. U.S. Pat. Nos. 2,730,456; 2,800,457; and 2,800,458 describe methods for capsule formation. Other useful methods for microcapsule manufacture are: U.S. Pat. Nos. 4,001,140; 4,081,376; and 4,089,802 describing a reaction between urea and formaldehyde; U.S. Pat. No. 4,100,103 describing reaction between melamine and formaldehyde in the presence of a styrenesulfonic acid. Microcapsules are also taught in U.S. Pat. Nos. 2,730,457 and 4,197,346. The more preferred process for forming microcapsules are from urea-formaldehyde resin and/or melamine formaldehyde resin as disclosed in U.S. Pat. Nos. 4,001,140; 4,081,376; 4,089,802; 4,100,103; 4,105,823; 4,444,699 or most preferably alkyl acrylate—acrylic acid copolymer capsules as taught in U.S. Pat. No. 4,552,811, each patent described is incorporated herein by reference to the extent each provides guidance regarding microencapsulation processes and materials.

In microencapsulation, small particles or droplets are surrounded by a coating, or embedded in a homogeneous or heterogeneous matrix and preferably surrounded by a coating, to give small capsules with many beneficial agents. Microencapsulation is a technique by which liquid droplets, oils, emulsions, solid particles or gaseous compounds are entrapped into thin films of a preferably food grade microencapsulating agent. The core may be composed of just one or several benefit agent ingredients and the wall may be single or multi-layered. The retention of the cores is governed by the core material's chemical functionality, charge distribution, rheology, solubility, polarity, size, osmotic pressure, and volatility, and the permeability of the wall which is further a function of variables including the composition, degree of cross-linking, porosity, solubility, thickness and porosity of the wall. The material inside the microcapsule is known as the core, internal phase, or fill, whereas the wall is the shell, coating, wall material, or membrane. Practically, the core may be a crystalline material, adsorbent particle, a suspension, an emulsion, a liquid, an oil, water, a suspension of solids, or a suspension of smaller microcapsules. Most microcapsules are small spheres with diameters comprised between a few micrometers and a few millimeters. The size and shape of formed microcapsules depend on the materials and methods used to prepare them. For purposes hereof microencapsulation can include such as: spray-drying, spray-cooling, spray-chilling, fluidized bed, air suspension coating, extrusion, centrifugal extrusion, freeze-drying, coacervation, rotational suspension separation, co-crystallization, and interfacial polymerization.

Common microencapsulation processes can be viewed as a series of steps. First, the core material which is to be encapsulated is emulsified or dispersed in a suitable dispersion medium. This medium is preferably aqueous but involves the formation of a polymer rich phase. Most frequently, this medium is a solution of the intended capsule wall material. The solvent characteristics of the medium are changed such as to cause phase separation of the wall material. The wall material is thereby contained in a liquid phase which is also dispersed in the same medium as the intended capsule core material. The liquid wall material phase deposits itself as a continuous coating about the dispersed droplets of the internal phase or capsule core material. The wall material is then solidified. This process is commonly known as coacervation.

Gelatin or gelatin-containing microcapsule wall material is well known. The teachings of the phase separation processes, or coacervation processes which are described in U.S. Pat. Nos. 2,800,457 and 2,800,458 are incorporated herein by reference. Uses of such capsules are described in U.S. Pat. No. 2,730,456. More recent processes of microencapsulation involve, and preferred herein, are the polymerization of urea and formaldehyde, monomeric or low molecular weight polymers of dimethylol urea or methylated dimethylol urea, melamine and formaldehyde, monomeric or low molecular weight polymers of methylol melamine or methylated methylol melamine, as taught in U.S. Pat. No. 4,552,811 is incorporated by reference. These materials are dispersed in an aqueous vehicle and the reaction is conducted in the presence of acrylic acid-alkyl acrylate copolymers

A method of encapsulation by a reaction between urea and formaldehyde or polycondensation of monomeric or low molecular weight polymers of dimethylol urea or methylated dimethylol urea in an aqueous vehicle conducted in the presence of negatively-charged, carboxyl-substituted, linear aliphatic hydrocarbon polyelectrolyte material dissolved in the vehicle, as taught in U.S. Pat. Nos. 4,001,140; 4,087,376; and 4,089,802 is incorporated by reference.

A method of encapsulating by in situ polymerization, including a reaction between melamine and formaldehyde or polycondensation of monomeric or low molecular weight polymers of methylol melamine or etherified methylol melamine in an aqueous vehicle conducted in the presence of negatively-charged, carboxyl-substituted linear aliphatic hydrocarbon polyelectrolyte material dissolved in the vehicle, is disclosed in U.S. Pat. No. 4,100,103, and is incorporated by reference.

A method of encapsulating by polymerizing urea and formaldehyde in the presence of gum Arabic as disclosed in U.S. Pat. No. 4,221,710 is incorporated by reference. This patent further discloses that anionic high molecular weight electrolytes can also be employed with the gum Arabic. Examples of the anionic high molecular weight electrolytes include acrylic acid copolymers. Specific examples of acrylic acid copolymers include copolymers of alkyl acrylate and acrylic acid including methyl acrylate-acrylic acid, ethyl acrylate-acrylic acid, butyl acrylate-acrylic acid and octyl acrylate-acrylic acid copolymers.

A method for preparing microcapsules by polymerizing urea and formaldehyde in the presence of an anionic polyelectrolyte and an ammonium salt of an acid as disclosed in U.S. Pat. Nos. 4,251,386 and 4,356,109 is incorporated by reference. Examples of the anionic polyelectrolytes include copolymers of acrylic acid. Examples include copolymers of alkyl acrylates and acrylic acid including methyl acrylate-acrylic acid, ethyl acrylate-acrylic acid, butyl acrylate-acrylic acid and octyl acrylate-acrylic acid copolymers.

The pressure sensitive adhesive is selected to be resealable, retaining tackiness when the pressure sensitive layer is separated, and preferably, able to repeatedly rupture or pull apart a portion of the microcapsules on each successive reopening of the package, bag or container providing for example a repeated aroma burst, depending on the active core selected for the microcapsules.

Pressure sensitive adhesive compositions are materials that will form a bond upon contacting the material to be adhered to. Adhesive compositions are considered resealable when the bond is able to be broken yet retains tack, preferably without significant damage to the substrate or layer and can be refastened with only moderate pressure and re-adhered. Pressure sensitive adhesives can include without limitation various acrylic adhesives styrene butadiene block copolymers, styrene isoprene block copolymers, acrylic acid esters, rubber adhesives, acrylic compounds of block copolymers, silicone adhesives, polysiloxanes, including combinations with elastomeric, non-elastomeric or thermoplastic compounds, tackifying resins, plasticizers, and modifying resins. A variety of pressure sensitive adhesives are described in U.S. Pat. Nos. 4,500,021; 3,239,478; 3,917,607 and Canadian Patent No. 1083745. Desirably, in some embodiments the adhesives can have an initial bond strength of from 50 to 400 grams per inch of width of adhesive, using a test such as PSTC-1 described in Example 2 of U.S. Pat. No. 4,500,021. Higher or lower bond strengths may be desirable depending on the application and tensile strength of the capsules and polyolefin layers. The above bond strengths although useful guides to selection, however are approximate and the skilled artisan can select appropriate pressure sensitive adhesives from the many commercially available and/or described in the above references, and adhesives with various bond strengths sold commercially such as Mactac™, (Stow, Ohio), Flexcon™ (Spencer, Mass.) Dow Corning (Milland, Mich.) 3M (St. Paul, Minn.), and Rohm and Haas.

In one aspect, the pressure sensitive adhesive layer is designed to be splittable. When the laminate layers are pulled apart the adhesive layer splits and in the process fractures a portion of the embedded microcapsules releasing their core material. The layers sandwiching the pressure sensitive adhesive layers preferably are barrier layers to passage of the core contents of the microcapsules, therefore the core materials provide a burst of release, such as aroma release before rupture of one of the barrier or polyolefin layers.

In FIG. 1 a four layer laminate is depicted heat sealed to a second laminate. A lumen area 14 is formed forward of the heat sealed areas of heat sealable low density layers 13. The laminate includes pressure sensitive adhesive layer 12 which contains dispersed microcapsules with a benefit agent such as fragrance or aroma. Layer 13 separates the lumen area from the pressure sensitive adhesive layer 12. Layer 13 would need to be ruptured to access the lumen contents and to allow the capsules to have contact therewith.

In FIG. 1 the laminate is depicted with a polyolefin layer 10 is shown opposite sealing layer 13 and sandwiching therebetween adhesive and microcapsule layer 12. In a preferred embodiment the tensile and/or adhesive strength of layer 12 is less than that of layer or layers 13. Therefore if the laminates are attempted to be separated in FIG. 1, either or both of the adhesive/capsule layers 12 preferentially separate and in the process rupture some capsules. Note that layers 13 would tend to stay in tact still separating the capsules from the lumen or package contents until such time that one of layers 13 is ruptured. Resealable layer 12 splits first resulting in aroma release and then, secondly, layer 13 is ruptured to access the package content.

In FIG. 1 layers 11 and 10 can be polyolefin. Optionally layer 10 and more preferably layer 11 can also be foil, nylon, a printable surface, polyvinylidene chloride, PET, ethylenevinyl acetate, paper, ethylene methacrylic acid copolymer, EVOH, polyethylene or oriented polypropylene or an optional adhesive layer or sealing layer.

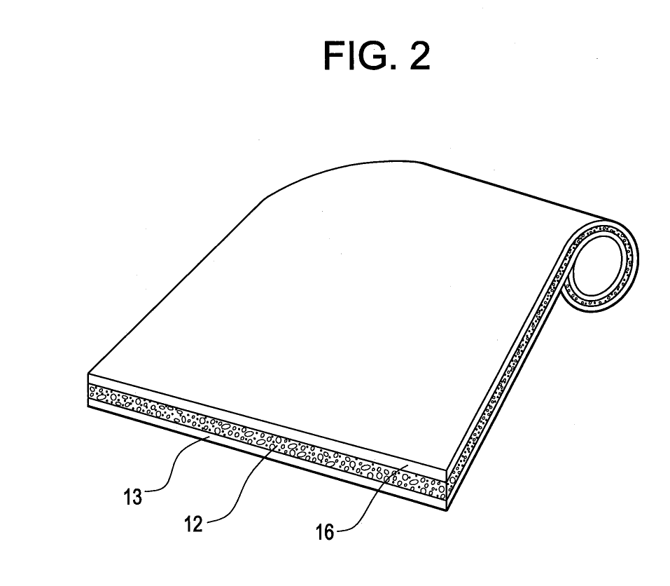

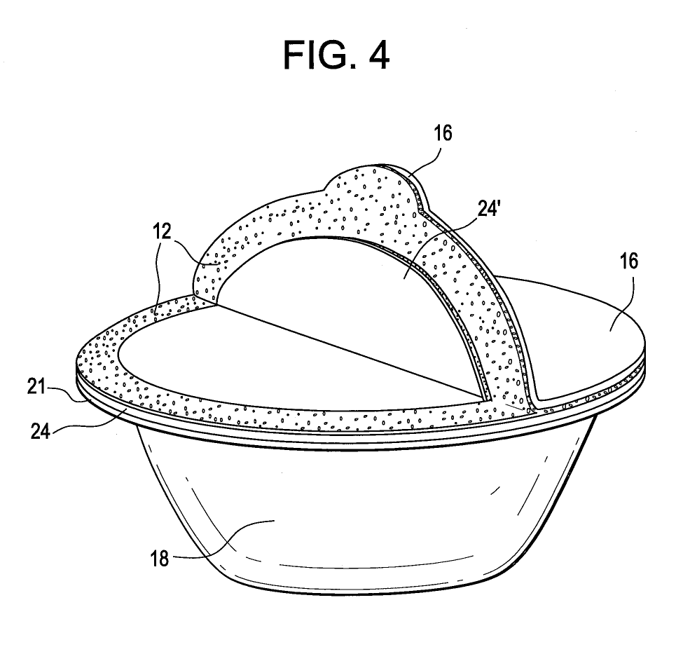

FIG. 2 depicts a roll of laminate material with a layer of pressure sensitive adhesive and dispersed microcapsules 12 sandwiched between a sealing layer 13 and a polyolefin layer 16. The sealing layer 13 facilitates bonding to another laminate as in FIG. 1 or to a container such as a bowl with a rim formed of sealing receptive material such as depicted in FIG. 4. FIG. 4 depicts a variation where the lid is formed of laminate material but the sealing layer is designed to preferentially leave rim portions of the sealing layer 24 on the container rim 21 when the lid is lifted at the same time exposing and fracturing capsules in the pressure sensitive adhesive layer 12. Rim portions of sealing layer 24 remain on rim 21 of container 18. The remaining lid portion of sealing layer 24′ lift with the lid. In this variation adhesive and capsule layer 12 is split along rim 21 fracturing some portion of microcapsules releasing their core material such as an aroma or fragrance material. The adhesive of layer 12 is preferably resealably tacky to permit repeated opening and closing of container 18.

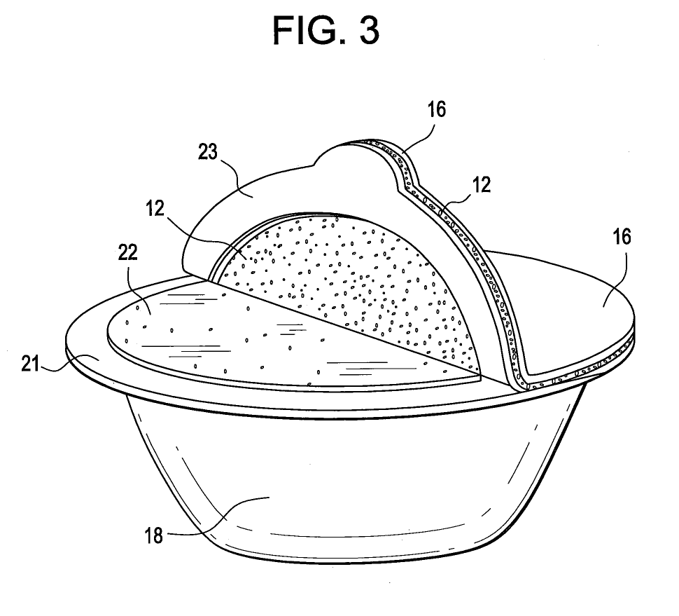

FIG. 3 depicts a container with a 3 layer lid. When lifted the inner circular area of the lid preferentially splits from the three layer laminate splitting the adhesive layer and microcapsules 12 while at the same time keeping the container sealed with polyolefin layer 22. Polyolefin layers 22 and 23 together form the bottom layer of the 3 layer lid.

In FIG. 3 bowl 18 is depicted with rim 21 and polyolefin layer 22 sealing the bowl when the lid composed of polyolefin layer 16, adhesive and capsule layer 12 and sealing layer 23 is lifted. To enable layer 22 to breakaway, the circumference of polyolefin 22, preferably a sealing layer, can be die cut or stamp cut or scored or perforation line or areas of weakness added in advance to promote clean cutting away from the lid material. When the lid is raised, adhesive and capsule layer 12 is exposed rupturing some fraction of capsules. The adhesive is pressure sensitive and tacky so as to be resealable. The interior of the bowl is separated from the capsules by layer 22 until layer 22 is deliberately ruptured to access the contents of the bowl.

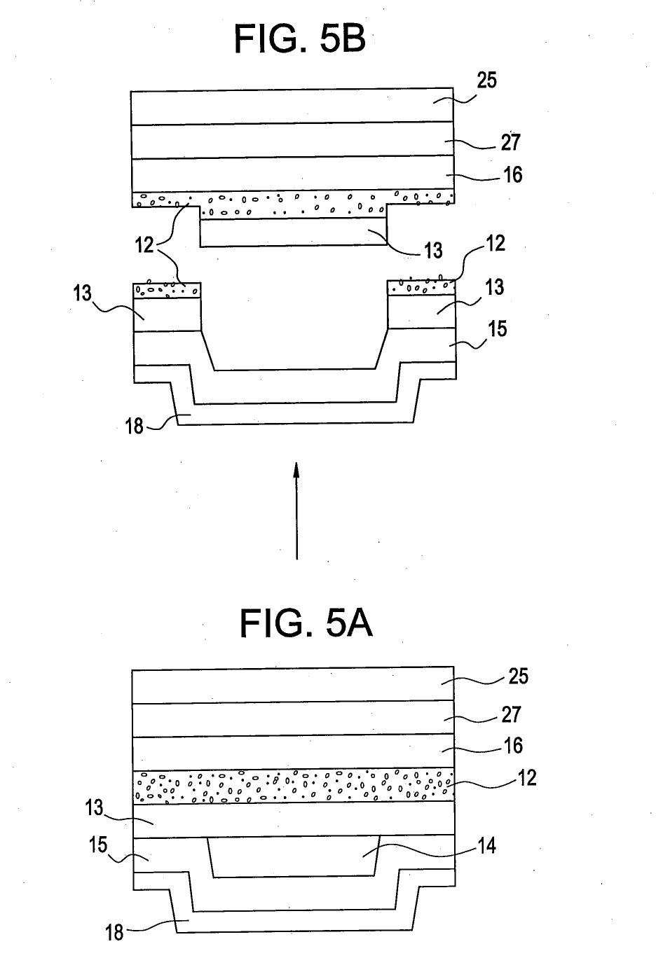

FIGS. 5A and 5B are a variation of the concept where the sealing layer adheres to the rim. When the lid is lifted, the pressure sensitive adhesive layer splits along the rim circumference and edge. In this variation microcapsules on the rim of the bowl and rim area of the lid are ruptured.

Unlike in FIG. 3, in FIG. 4 a cover layer is not left behind over the bowl when the lid is lifted.

FIGS. 5A and 5B depicts a cross section view of a bowl and laminate design similar to FIG. 4. In FIG. 5A container 18 is depicted with a sealing layer 15 together forming a wall area or cavity or lumen 14. A sealing layer 13 bridges lumen 14 and is coextensive with adhesive and microcapsule layer 12. Opposite layer 12 is a substrate 16 such as a polyolefin layer over which optionally is laminated or otherwise applied a printing layer or adhesive layer and optionally a further substrate polyolefin layer 25. Layer 25 for purposes hereof in this type of construction is intended interpreted as “in continuous and direct contact with coextensive with” adhesive layer 12, or equivalent for purposes hereof. The optional layers 27 and 16 simply facilitate the continuous and direct contact with the adhesive layer.

In FIG. 5B, the container cross section depicts the container 18 having the lid removed in a construction akin to FIG. 4 where the rim portion of layer 12 splits but a portion of sealing layer 13 is raised within the lid.

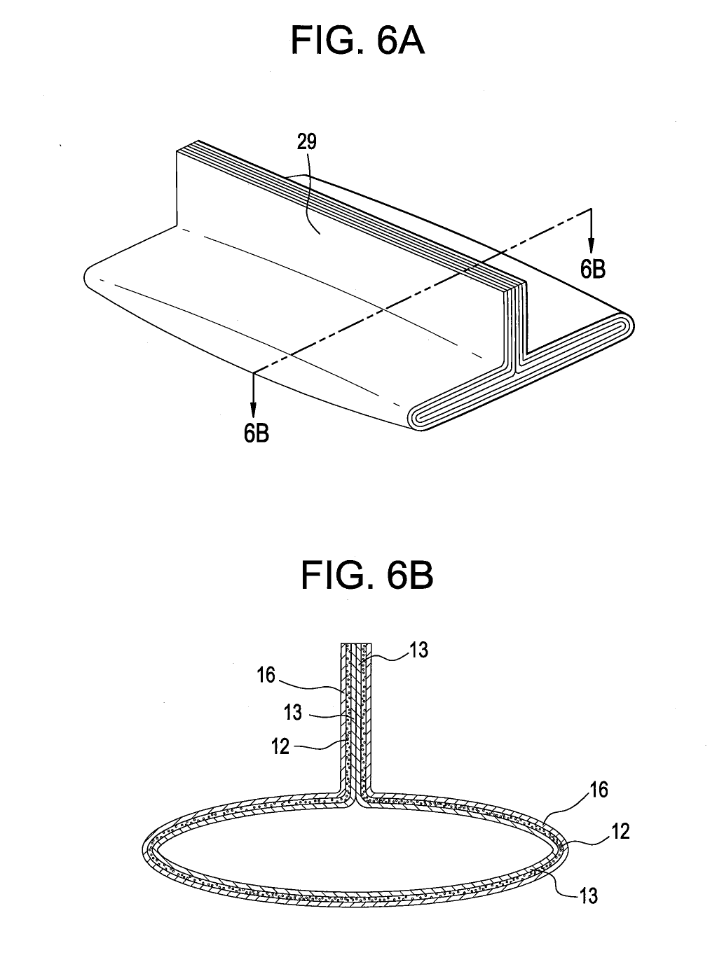

FIG. 6 illustrates the laminate of the invention used in the formation of a packaging material employing heat sealed ends and a conventional seal.

In FIG. 6, FIG. 6B is a close up of the edge of the container of FIG. 6A. Seal 29 is as shown is a fin seal.

In a preferred embodiment, adhesive and capsule layer 12 would be designed to preferentially separate before sealing layers 13 separate from each other, thereby first fracturing some portion of microcapsules releasing aroma before a layer 13 is ruptured to provide access to the container contents. Layer 12 is preferably resealably tacky.

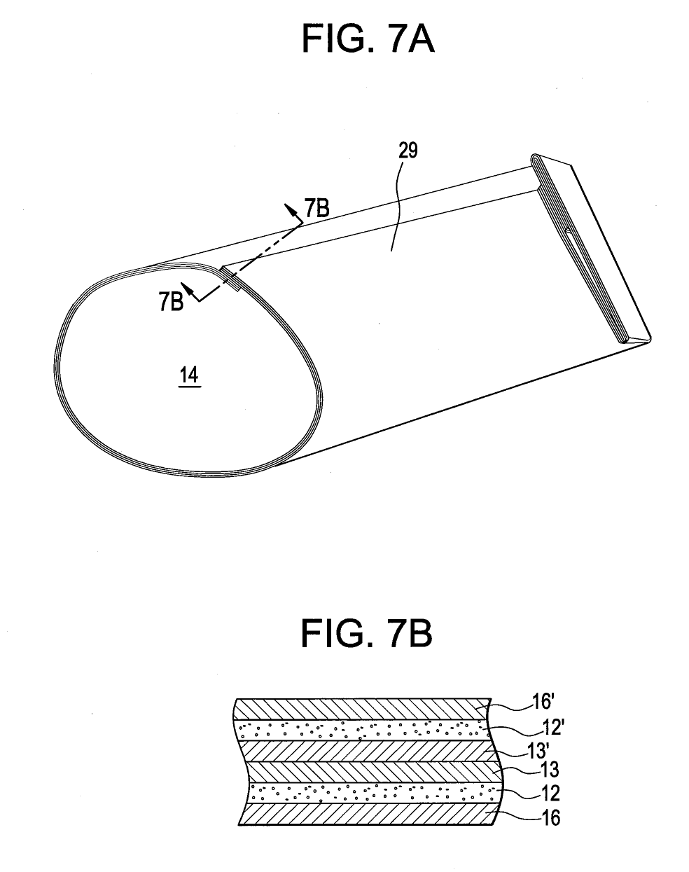

FIG. 7 illustrates the laminate of the invention used in the formation of a packaging material employing a heat sealed end that is further folded and a lap seal. The other open end can also be pressed and heat sealed forming a pouch or container. Alternatively, the open end can be folded and heat sealed similar to the first heat sealed end.

Seal 29 as shown in FIG. 7A is a lap seal. The laminate of FIG. 7 shown is a close up view in FIG. 7B comprises at least a three layer laminate with sealing layers 13 and 13′, adhesive and capsule layers 12 and 12′ and polyolefin layers 16 and 16′.

The laminate of the present invention may be comprised of multiple layers coextruded or laminated, such as, for example, up to 8 layers, or even up to 16 or more layers, including one or more layers each of the polypropylene, polyethylene, and barrier layers such as EVOH or nylon layers.

Exemplary internal layers within the laminate include but are not limited to foil, nylon, polyvinylidene chloride, polyethylene terephthalate (PET), ethylene/vinyl acetate copolymers, paper, ethylene/acrylic acid copolymers, ethylene/methacrylic acid copolymers, EVOH, polyethylene, metalized polyethylene terephthalate, or oriented polypropylene (OPP), etc. The specific identity of such layers is not critical to the practice of the present invention, but may be determined based on the specific utility contemplated for the laminate.

A preferred barrier material comprises an ethylene/vinyl alcohol (EVOH) copolymer. EVOH generally has an ethylene content of from 15-70 mol %, preferably from 25-55 mol %, which has a degree of hydrolysis for the vinyl ester moiety of from 85-99%, and preferably 95% or greater. If the ethylene content of the EVOH copolymer is greater than about 70 mol %, the gas barrier properties exhibited thereby are diminished, as is also exhibited if the degree of hydrolysis is less than about 95%.

For purposes of the present invention, the term barrier layer is intended to mean that the layer is impermeable to gases or liquids. In particular, the layer is impermeable to oxygen or to core contents contained in the microcapsules.

The EVOH copolymer may further be copolymerized with comonomers such as but not limited to propylene, butylene, unsaturated carboxylic acid (such as methacrylic acid, an ester of an unsaturated carboxylic acid (such as methyl(meth)acrylate), vinylpyrrolidone, etc. Such additional monomers may be present in amounts which do not otherwise disadvantageously affect the desired gas barrier properties of the EVOH film.

It is also within the scope of the present invention to employ two or more types of EVOH polymers in the EVOH film, as well as various conventional additives such as heat stabilizers, UV light absorbers, sealant enhancers, antioxidants, coloring agents, fillers, etc., in amounts which do not affect the desired properties of the EVOH layer.

EVOH polymers are well known in the art and commercially readily available. See, for example, U.S. Pat. Nos. 3,510,464; 3,560,461; 3,847,845; 3,595,740; and 3,585,177, which describe well-known methods for the production of such polymers.

The polyolefin sealing layer usually refers to an outer or inner film or inner layer, or layers, involved in the sealing of the film to itself, another film layer of the same or another film, and/or another article which is not a film. In general, the sealing layer is a layer of any suitable thickness, that provides for the sealing of the film laminate to itself or another layer. The phrase can refer to the interior surface film layer of a package, as well as supporting layers of the interior surface of the sealing layer. The inside layer frequently also serves as a food contact layer in the packaging of foods. In general, sealing layers employed include polyolefins such as linear low density polyethylene, very low density polyethylene, homogeneous polymers such as metallocene catalyzed ethylene/alpha-olefin copolymer, etc.), polypropylene homopolymers and copolymers, polyamide, polyester (e.g., polyethylene terephthalate glycol), ethylene/ester copolymer (e.g., ethylene/vinyl acetate copolymer), ionomer, and functional equivalents thereof. More specifically, the sealant layer may comprise one or more materials or for purposes hereof a blend of a sealant enhancing composition, such sealant enhancing compositions being selected from various blends including any of the foregoing polyolefins and/or including one or more thermoplastic resins and additives inclusive of: polyolefins polymerized by using a single-site catalyst or metallocene catalyst inclusive of linear low-density polyethylene and very low-density polyethylene; conventional types of ethylene-olefin copolymers inclusive of “LLDPE” and “VLDPE” in terms of generally accepted abbreviations; ethylene-vinyl acetate copolymer (“EVA”), ethylene-methacrylic acid copolymer (“EMAA”), ethylene-methacrylic acid-unsaturated aliphatic carboxylic acid copolymer, low-density polyethylene, ionomer resin (“10 (resin)”), ethylene-acrylic acid copolymer, ethylene-methyl acrylate copolymer (“EMA”), and ethylene-butyl acrylate copolymer (“EBA”). Such a preferred class of sealable resins may be termed as an ethylene copolymer, typically a copolymer of a major amount (i.e., more than 50 wt. %) of ethylene with a minor amount (i.e., less than 50 wt. %, preferably up to 30 wt. %) of a vinyl monomer copolymerizable with ethylene selected from the group consisting of alpha-olefins having 3 to 8 carbon atoms, and unsaturated carboxylic acids and unsaturated esters of carboxylic acids having up to 8 carbon atoms, inclusive of acrylic acid, methacrylic acid, acrylate esters, methacrylate esters and vinyl acetate, or an acid-modified product of the ethylene copolymer (preferably modified with up to 3 wt. % of an unsaturated carboxylic acid). It is also possible to use a thermoplastic resin, such as polypropylene resin, polyester resin or aliphatic nylon. The sealable resin may preferably have a melting point of up to about 135° C., or even up to about 150° C. It is also possible to use blends with other additives including at least one species of a sealable resin within an extent of preferably not impairing the transparency of the resultant film or a sealed product thereof. The respective layers may be of any suitable thickness, as the thickness of the respective layers is not critical to practice of the present invention. By way of example, the thickness of the individual film layers in the laminate may range from about 1 μm to about 150μ, and more preferably, from about 7 μm to about 100μ. However, any suitable thickness may be employed with advantage.

The present invention also encompasses those embodiments where one or more of the films which comprise the laminate are oriented in one or more of the transverse or machine directions. For instance, non-oriented polyethylene and/or polypropylene films can be coated onto oriented polyethylene and/or polypropylene (or polyolefin) layers.

The laminate of the present invention can be formed by any suitable method. Exemplary methods which are suitable for formation of the laminate include extrusion, co-extrusion, extrusion coating, adhesive lamination, extrusion lamination, blowing and casting.

Optionally, the adhesive seal layer is comprised of a polyolefin elastomer as one component, in admixture with a heat-sealable polyethylene polymer. The polyethylene sealant polymer may be, for example, a polyethylene plastomer, or a polyethylene sealant material, or a combination of the two.

Preferably, the polyolefin elastomer comprises a polymer wherein the ethylene monomers are polymerized with an alpha-olefin having from 4 to 10 carbon atoms such that the resulting polymer composition has a narrow molecular weight distribution (Mw/Mn), homogeneous branching and controlled long chain branching. Suitable alpha-olefins include, but are not limited to, 1-octene, 1-butene, 1-hexene and 4-methyl-pentene.

Exemplary polymers include those which are known in the art as “metallocene”, “constrained geometry” or “single-site” catalyzed polymers such as those described in U.S. Pat. No. 5,472,775; U.S. Pat. No. 5,451,450; U.S. Pat. No. 5,539,124; and U.S. Pat. No. 5,554,775.

The metallocene process generally uses a metallocene catalyst which is activated, i.e. ionized, by a co-catalyst. Examples of metallocene catalysts include bis(n-butylcyclopentadienyl)titanium dichloride, bis(n-butylcyclopentadienyl)zirconium dichloride, bis(cyclopentadienyl)scandium chloride, bis(indenyl)zirconium dichloride, bis(methylcyclopentadienyl)titanium dichloride, bis(methylcyclopentadienyl)zirconium dichloride, cobaltocene, cyclopentadienyltitanium trichloride, ferrocene, hafnocene dichloride, isopropyl(cyclopentadienyl,-1-flourenyl)zirconium dichloride, molybdocene dichloride, nickelocene, niobocene dichloride, ruthenocene, titanocene dichloride, zirconocene chloride hydride, zirconocene dichloride, among others.

Numerous other metallocene catalysts, single site catalysts, constrained geometry catalysts and/or comparable catalyst systems are known in the art; see for example, The Encyclopedia of Chemical Technology, Kirk-Othemer, Fourth Edition, vol. 17, Olefinic Polymers, pp. 765-767 (John Wiley & Sons 1996).

The polyethylene sealant layer may comprise with advantage a combination of one or more of the polyethylene components (such as a low density polyethylene (LDPE), linear low density polyethylene (LLDPE), linear medium density polyethylene (LMDPE), linear very low density polyethylene (VLDPE), linear ultra low density polyethylene (ULDPE), metallocene linear low density polyethylene (MLLDPE), high density polyethylene (HDPE), or the like), together with a polyethylene plastomer.

When used in combination, typical weight ratios of the polyethylene component and the polyethylene plastomer range from 95:5 to 5:95, although the particular ratio is not critical. The amount of plastomer which is present is determined by the contemplated end use. That is, the presence of higher amounts of the plastomer in the polyethylene film will decrease the initiation temperature of the film for purposes of bonding, but may also detract from the physical properties exhibited by the film. It is thus desirable to provide sufficient plastomer to achieve a desired balance of physical properties.

As taught in commonly assigned Ser. No. 61/202,651 filed Mar. 23, 2009, in an alternate embodiment it has also been found to be useful to incorporate polypropylene plastomer into polyethylene sealing layers in order to enhance the compatibility of the sealing layer to polypropylene during bonding. The polypropylene plastomer may be used in conjunction with a polyethylene plastomer, or separately therefrom, upon admixture with the polyethylene sealing layer.

When so used, the polypropylene plastomer will generally be present in the polyethylene sealing layer in an amount of from about 1 to about 25% by weight, although the amount may vary depending upon the desired properties desired for the laminate.

Again, the amount of the polypropylene plastomer and/or polyethylene plastomer which is employed in admixture with the polyethylene sealing component to form the sealing film will depend to a certain extent upon the desired end use of the laminate, since not only will the presence of the polypropylene plastomer will enhance the compatibility for purposes of bonding to the oriented polypropylene layer, but the presence of the plastomer will change the physical properties of the polyethylene film.

Polyolefin elastomers are typically copolymers of propylene and ethylene. Such elastomers are available from Mitsui under various product designations, as well as under the trademark NOTIO™, and from Exxon under various product designations as well as under the trademark VISTAMAXX™.

The polyolefin elastomer/polyethylene polymer blend which forms an outer layer of the laminate may be formed by in any suitable manner known to those skilled in the art including blown or cast extrusion or co-extrusion, or extrusion coating. The polyolefin elastomer will generally comprise from 1 to 50% by weight of the total mixture in order to enable the desired advantages to be achieved, preferably from about 5 to 25% by weight.

The laminate of the present invention may be used in a number of applications. The laminate finds particular utility in the packaging art, such as multilayer packaging consisting of shrink films and barrier shrink applications, packages formed via form/fill/seal steps, packaging for foods, liners, etc.

Unless otherwise indicated, all measurements herein are on the basis of weight and in the metric system. All references cited herein are expressly incorporated herein by reference.

### Example 1

A four layer coextrusion laminate similar to that depicted in FIG. 1 was produced via a blown film process. The overall thickness of the film laminate was 2.0 mils. The outer layer 10 (away from what would be the inside of the package) was a polyolefin HDPE layer with a density of 0.956 in. (2.43 cm) and was 52% of the thickness of the film. The next layer 11 was a 0.920 density, 1.0 Ml (10⁻³ of an inch (0.0254 millimeter), LLDPE which was 16% of the film laminate. The next layer 12 was 20% of the film thickness and was a blend of pressure sensitive adhesive (PSA) and polymicrocapsules containing a peppermint oil core material. The PSA and microcapsules were dry blended prior to extruding. The PSA is a 40 MI, 0.960 density material. Layer 13 of the laminate was a 0.924 LDPE.

The laminate lends itself to use with various types and processes of microcapsule formation. Although illustrated with a polyalkyl acrylate wall, the invention is not limited to one particular type of wall. Various other microcapsule walls such as gelatin, urea formaldehyde, melamine formaldehyde, gelatin gum arabic, polyacrylate and the like can be successfully employed.

MF/PAA wall
Peppermint oil core
Volume weighted mean capsule size—11 μm

A melamine formaldehyde and polyalkyl acrylate microcapsule is preparable according to the process of U.S. Pat. No. 4,552,811 incorporated herein by reference. A first mixture is prepared by dispersing alkyl acrylate-acrylic acid copolymer in water and adjusted to be slightly acidic. Peppermint oil is emulsified into the first mixture. The ingredients to form the capsule wall material are prepared as follows: 9 grams of a corresponding capsule wall material copolymer pre-polymer (butylacrylate-acrylic acid copolymer) and 90 grams of water are combined and adjusted to pH 5.0. To this mixture is added 28 grams of a partially methylated methylol melamine resin solution. This mixture is added to the peppermint oil-in-water emulsion. High speed blending is used to achieve a particle size from 10 to 20 microns. The temperature of the mixture is gradually raised to at least 65 degrees Centigrade, and maintained at this temperature for 8 hours with continuous stirring to initiate and complete encapsulation. To form the acrylic acid-alkyl acrylate copolymer capsule wall, the alkyl group can be selected from any of ethyl, propyl, butyl, amyl, hexyl, cyclohexyl, 2-ethylhexyl, or other alkyl groups having from one to about sixteen carbons, preferably one to eight carbons. The microcapsules are blended with the PSA material.

During extrusion, the laminate was wound into a tube about 14″ (25.56 cm) wide. After extrusion the laminate was formed into a package by heat sealing edge areas of LDPE layer 13 to itself by applying heat to edge areas along the periphery of outside HDPE layer 10. A package/pouch was formed. Upon opening of the resultant package/pouch by pulling apart the heat sealed portion of the film laminate splits along the PSA layer. First, this exposes the PSA layer which is tacky and provides a method to reseal the package by pressing the package back together along the broken seal by pressing the split apart PSA layer back together. Opening also breaks some of the microcapsules in the PSA layer which allows the peppermint oil to diffuse giving an aroma burst. Secondly, in the process of opening, the LDPE layer 13 on one side of the package can be torn through for content access. If the package is resealed by pressing it back together and then pulled open again more capsules are broken resulting in a further aroma burst. This process can be repeated several times (10 to 20).

### 52% HDPE

### 16% LLDPE

20% PSA+capsules Capsules were 1% of the layer by weight and contained spearmint essential oil as a core material

### 12% LDPE

PSA—Bostik M550 (Wauwatosa, Wis.) resealable adhesive.

The principles, preferred embodiments, and modes of operation of the present invention have been described in the foregoing specification. The invention which is intended to be protected herein, however, is not to be construed as limited to the particular form disclosed, since these are to be regarded as illustrative rather than restrictive. While particular embodiments of the present invention have been illustrated and described, it would be obvious to those skilled in the art that various other changes and modifications can be made without departing from the scope of the invention. It is therefore intended to cover in the appended claims all such changes and modifications that are within the scope of this invention.

All documents cited in the specification herein are, in relevant part, incorporated herein by reference for all jurisdictions in which such incorporation is permitted. The citation of any publication is for its disclosure prior to the filing date and should not be construed as an admission that such publication is prior art or that the present invention is not entitled to antedate such publication by virtue of prior invention. To the extent that any meaning or definition of a term in this document conflicts with any meaning or definition of the same term in a document incorporated by reference, the meaning or definition assigned to that term in this document shall govern.

What is claimed is:

1. A laminate comprised of:
a polyolefin sealing layer;
a pressure sensitive adhesive layer and microcapsules containing an active core material, the microcapsules dispersed in a resealably tacky pressure sensitive adhesive layer;
the pressure sensitive adhesive sandwiched between at least two layers by being disposed along substantially an entire surface of the polyolefin sealing layer and in continuous and direct contact with a second polyolefin layer opposing and coextensive with the polyolefin sealing layer; and
the microcapsules in the pressure sensitive adhesive layer having less tensile strength than the adhesive such that a fraction of the microcapsules rupture releasing core material when the pressure sensitive adhesive layer is separated when the polyethylene and first polyolefin layers sandwiching the pressure sensitive adhesive are pulled apart.

2. The laminate according to claim 1 wherein the polyolefin sealing layer is a blend of a sealant enhancing composition.

3. The laminate according to claim 1 wherein the polyolefin sealing layer is selected from a low density polyethylene or a polyolefin elastomer-modified polyethylene.

4. The laminate according to claim 3 wherein the polyolefin layer opposing the sealing layer is a top layer of the laminate and is selected from films consisting of polypropylene, oriented polypropylene, biaxially oriented polypropylene polyethylene and elastomer-modified polyethylene.

5. The laminate according to claim 1 wherein the laminate includes in addition one or more additional layers intermediate or over the polyolefin layers, each additional layer being independently selected from foil, nylon, polyvinylidene chloride, polyethylene terephthalate, polypropylene, ethylene vinyl acetate copolymer, paper, ethylene acrylic acid copolymer, ethylene methacrylic acid copolymer, EVOH, and polyethylene.

6. A pouch made by heat sealing the sealing layers of two laminates according to claim 1.

7. An article made by heat sealing areas of the sealing layer of a laminate according to claim 1 to itself forming a fin seal.

8. An article made by heat sealing areas of the sealing layer of claim 4 to areas of the top layer forming a lap seal.

9. A laminate comprised of:
a low density polyethylene sealing layer forming one side of said laminate;
a pressure sensitive adhesive layer and microcapsules containing an active core material, the microcapsules dispersed in the pressure sensitive adhesive layer;
the pressure sensitive adhesive sandwiched between at least two layers of the laminate by being disposed along substantially an entire surface of the low density polyethylene sealing layer and in continuous and direct contact with a first polyolefin layer opposing and coextensive with the low density polyethylene sealing layer, the first polyolefin layer forming an opposing side of the laminate.

10. A pouch made by heat sealing the polyethylene sealing layers of two laminates according to claim 9.

11. An article made by heat sealing the polyethylene sealing layer of a laminate according to claim 9 to itself.

12. The laminate according to claim 9 wherein in addition the laminate further comprises:
at least a second polyolefin layer disposed over the first polyolefin layer;
the microcapsules in the pressure sensitive adhesive layer having less tensile strength than the adhesive such that a fraction of the microcapsules rupture releasing core material when the pressure sensitive adhesive layer is separated when the polyethylene and first polyolefin layers sandwiching the pressure sensitive adhesive are pulled apart.

13. A container comprising a first laminate heat sealed to a second laminate,
the first laminate comprising at least one low density polyethylene sealing layer and a polyolefin layer, the second laminate being in the shape of a container, the polyethylene sealing layer forming a top surface of the container
the second laminate comprising:
a low density polyethylene sealing layer;
a pressure sensitive adhesive layer and microcapsules containing an active core material, the microcapsules dispersed in the pressure sensitive adhesive layer;
the pressure sensitive adhesive sandwiched between two layers by being disposed along substantially an entire surface of the low density polyethylene sealing layer and in continuous and direct contact with a first polyolefin layer opposing and coextensive with the low density polyethylene sealing layer; and
at least a second polyolefin layer disposed over the first polyolefin layer;
the microcapsules in the pressure sensitive adhesive layer having less tensile strength than the adhesive such that a fraction of the microcapsules rupture releasing core material when the pressure sensitive adhesive layer is separated when the polyethylene and first polyolefin layers sandwiching the pressure sensitive adhesive are pulled apart when the first laminate is pulled from the second laminate

14. A container comprising a first laminate and a second laminate,
the first laminate comprising at least one low density polyethylene sealing layer and a polyolefin layer, the second laminate being in the shape of a container, the polyethylene sealing layer forming a top surface of the container
the second laminate comprising:
a low density polyethylene sealing layer;
a pressure sensitive adhesive layer and microcapsules containing an active core material, the microcapsules dispersed in the pressure sensitive adhesive layer;
the pressure sensitive adhesive sandwiched between two layers by being disposed along substantially an entire surface of the low density polyethylene sealing layer and in continuous and direct contact with a first polyolefin layer opposing and coextensive with the low density polyethylene sealing layer; and
at least a second polyolefin layer disposed over the first polyolefin layer;
whereby the sealing layers of the first laminate and the second laminate can be heat sealed together to close the container.

15. A package having an aroma burst, the package comprising a laminate comprised of:
a polyolefin sealing layer;
a pressure sensitive adhesive layer and microcapsules containing an active core material, the microcapsules dispersed in a resealably tacky pressure sensitive adhesive layer;
the pressure sensitive adhesive sandwiched between at least two layers by being disposed along substantially an entire surface of the polyolefin sealing layer and in continuous and direct contact with a second polyolefin layer opposing and coextensive with the polyolefin sealing layer; and
the microcapsules in the pressure sensitive adhesive layer having less tensile strength than the adhesive such that a fraction of the microcapsules rupture releasing core material when the pressure sensitive adhesive layer is separated when the polyethylene and first polyolefin layers sandwiching the pressure sensitive adhesive are pulled apart, the laminate polyolefin sealing layer having a portion being sealed to itself or to a second laminate.

16. The package according to claim 15 wherein the portion sealed is by means of a fin seal or lap seal.

17. The package according to claim 15 wherein a lumen is formed when the laminate is sealed to itself or to a second laminate, the pressure sensitive adhesive layer being isolated from the lumen by a continuous polyolefin layer until the polyolefin layer is ruptured.

18. A heat sealable laminate comprised of at least three layers comprising an oriented polypropylene film layer on one side of said laminate, and a polyolefin elastomer-modified polyethylene sealant film forming an opposing side of a laminate, an interior layer of said laminate comprising a resealable pressure sensitive adhesive layer and microcapsules containing an active core material, the microcapsules dispersed in the resealable pressure sensitive adhesive;
the pressure sensitive adhesive layer sandwiched between the oriented polypropylene film layer and the polyolefin elastomer-modified polyethylene sealant film layers and substantially coextensive with the polypropylene film and polyethylene sealant film layers;
the microcapsules in the pressure sensitive adhesive layer having less tensile strength than the adhesive such that a fraction of the microcapsules rupture releasing core material when the pressure sensitive adhesive layer is separated when the polyethylene sealant film layer and polypropylene film layers sandwiching the pressure sensitive adhesive are pulled apart.

19. The laminate of claim 18, wherein said sealant film is comprised of a mixture of said polyolefin elastomer and a polyolefin plastomer.

20. The laminate of claim 18, wherein said sealing layer is comprised of a mixture of a polypropylene elastomer and a polyethylene sealant material.

21. The laminate of claim 18, wherein said oriented polypropylene film is a biaxially oriented polypropylene film.

22. The laminate of claim 18, further comprising a barrier layer intermediate said oriented polypropylene layer and said polyethylene film layer.

23. The laminate of claim 22, wherein said barrier layer is comprised of EVOH.

24. The laminate of claim 22, wherein said polyethylene sealant film comprises a mixture of a polyolefin elastomer and a polyethylene sealant material.

25. The laminate of claim 24, wherein said polyolefin elastomer is a polypropylene elastomer.

26. The laminate of claim 18, wherein said polypropylene polymer is formed from a monomer represented by the formula H₂C═CR₁R₂ wherein, independently, R₁ may be H or a C₂-C₆ alkyl group, and R₂ is H, a C₂-C₆ alkyl group, or a C(O)OR₃ group wherein R₃ is H or a C₂-C₆ alkyl group.

27. The laminate of claim 18, wherein said polyethylene sealant film is comprised of low density polyethylene (LDPE), linear low density polyethylene (LLDPE), linear medium density polyethylene (LMDPE), linear very low density polyethylene (VLDPE), linear ultra low density polyethylene (ULDPE), metallocene linear low density polyethylene (MLLDPE), high density polyethylene (HDPE), Polyolefin Plastomer (PO), or mixtures thereof.

28. The laminate of claim 18, wherein said polyolefin elastomer is present in said polyethylene sealant film in an amount of from about 1 to about 25 percent by weight.

29. The laminate of claim 18, further including as one or more additional layers intermediate said outer layers, said additional layers comprising a layer selected from foil, nylon, polyvinylidene chloride, polyethylene terephthalate, oriented polypropylene, ethylene/vinyl acetate copolymers, paper, ethylene/acrylic acid copolymers, ethylene/methacrylic acid copolymers, EVOH, paper, and polyethylene.

30. A flexible pouch formed from the laminate of claim 18.

31. The laminate of claim 18 wherein the active material is selected from perfume, fragrance, aroma, flavorant, essential oil and flavor enhancer.
